(19) United States
(12) Patent Application Publication
(10) Pub. No.: US 2007/0183001 A1
(43) Pub. Date: Aug. 9, 2007

(54) Image processing apparatus, image processing method, program and recording medium

(75) Inventor: Masatsugu Koguchi, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Konica Minolta Business Technologies, Inc., Tokyo (JP)

(21) Appl. No.: 11/474,791

(22) Filed: Jun. 26, 2006

(30) Foreign Application Priority Data
Feb. 6, 2006 (JP) 2006-028830

(51) Int. Cl. H04N 1/38

(52) U.S. Cl. 358/464; 358/521

(57) ABSTRACT

Disclosed is an image processing apparatus including: an image-processing member which detects a corrected area of an original image based on gradation level of original image data obtained by reading the original image, and forms image data where the corrected area is processed to be discernible.

### CROSS-REFERENCE TO RELATED APPLICATION

The present U.S. patent application claims a priority under the Paris Convention of Japanese patent application No. 2006-28830 filed on February 6, 2006, and shall be a basis of correction of an incorrect translation.

### BACKGROUND

1. Field of the Invention

The present invention relates to an image processing apparatus, an image processing method, a program and a recording medium in which a trace of correction is detected from image data of an original to be read, and the trace of correction is made to be discernible.

2. Description of Related Art

It has been getting common to digitize documents such as reports, proposals, various databases, and the like. Such digitalization draws attention, because it is easier to manage the digitized documents than conventional paper media and the digitalization contributes to cost reduction and environmental solution.

On the other hand, some documents are still kept and managed in paper media. These are various contract documents, receipts, official documents and the like. They do not fit to the digitalization because it is difficult to discern a correction or falsification which has been made afterward. Moreover, various applicable laws require storing and managing the document in paper media.

In order to prevent such correction or falsification made on digital data, JP 2003-264685A discloses that character information of an image is previously embedded in the printed matter thereof, and when the printed matter is read with a scanner or the like, it is judged whether or not a correction or falsification has been made by comparing the character information with the actual original image data.

However, there is a problem in the disclosure of JP 2003-264685A that the character information is previously embedded in the printed matter. That is, in the technique disclosed in JP 2003-264685A, a pattern block which encodes a content of the original is previously recorded at top, bottom, right or left margin of the original, or the like. The judging section compares the content extracted from the pattern block by an embedded information extracting member with the original image, so as to detect falsification of the original content. Therefore, the technique disclosed in JP 2003-264685A requires a step of embedding the pattern block previously. Therefore, it is supposed that this technique cannot be applied to a certain field because some images do not have enough space to embed the pattern block.

Moreover, it is also problematic that, when the pattern block is corrected or falsified with a correction tape or correction agent (hereinafter referred to as “correction or the like” or just “correction”) and thereafter a copy thereof is made, a region where correction or the like has been made cannot be determined on the copy.

When an original is corrected with a correction tape or correction agent before the original is digitized with a reading device such as a scanner, the corrected area may not be detectable on the image data. That is, when whiteness of the recording paper is close to that of the correction tape or the like, the corrected area cannot be determined on the image data (and visually). Thus, there is a problem that it is not discernible whether or not correction or the like has been made. Particularly, when background removal processing is performed on the read image data, the correction or the like is nearly always indiscernible.

### SUMMARY

The present invention has been made to solve the above problem. It is one of objects of the present invention to detect an area of correction or the like which has been made on an original image, and to form and output image data by which the corrected area can be displayed with emphasis so as to be easily discerned by visual observation.

According to a first aspect of the invention, a image processing apparatus comprising: an image processing member which detects a corrected area of an original image based on gradation level of original image data obtained by reading the original image, and forms image data where the corrected area is processed to be discernible.

According to a second aspect of the invention, a image processing method comprising the steps of: detecting a corrected area of an original image based on gradation level of original image data obtained by reading the original image; and forming image data where the corrected area of the original image data is processed to be discernible.

According to a third aspect of the invention, a program for causing a computer to carry out the functions of: a detecting function which detects a corrected area of an original image based on gradation level of original image data obtained by reading the original image; and an emphasizing function which forms image data where the corrected area of the original image data is processed to be discernible.

According to a fourth aspect of the invention, a computer-readable recording medium storing a program of claim 17.

### BRIEF DESCRIPTION OF THE DRAWINGS

These and other objects, advantages and features of the present invention will become more fully understood from the detailed description given hereinbelow and the appended drawings, and thus are not intended as a definition of the limits of the present invention, and wherein;

FIG. 1 is a block diagram showing a functional constitution of the reading apparatus of the embodiment in the present invention,

FIG. 2 is a schematic view showing an example of an external connection of the reading apparatus shown in FIG. 1,

FIG. 3 is a schematic view showing an example of a configuration screen of reading condition on an operation display of the reading apparatus shown in FIG. 1,

FIG. 4 is a flowchart showing a procedure in the reading apparatus shown in FIG. 1,

FIG. 5 is a flowchart showing a procedure of a corrected area emphasizing process of the reading apparatus shown in FIG. 1,

FIG. 6 is a schematic view showing a procedure of an area determination process of the reading apparatus shown in FIG. 1,

FIG. 7 is a graph schematically showing gamma property of a gamma curve in the case where the corrected area emphasizing process is not performed in the reading apparatus shown in FIG. 1,

FIG. 8 is a graph schematically showing gamma property of a gamma curve in the case where the corrected area emphasizing process is performed in the reading apparatus shown in FIG. 1,

FIG. 9 is a view schematically showing original image data read in the reading member of the reading apparatus shown in FIG. 1,

FIG. 10 is a view schematically showing image data which has been subjected to a gamma correction of the corrected area emphasizing process in the reading apparatus shown in FIG. 1,

FIG. 11 is a schematic view showing a correction tape trace area of the corrected area in the reading apparatus shown in FIG. 1, and

FIG. 12 is a view schematically showing image data where gradation level of the correction tape trace on the original image data, which is the corrected area, has been converted.

### DETAILED DESCRIPTION OF THE PREFERRED EMBODIMENT

Hereinafter, an embodiment of the invention will be described with reference to the drawings.

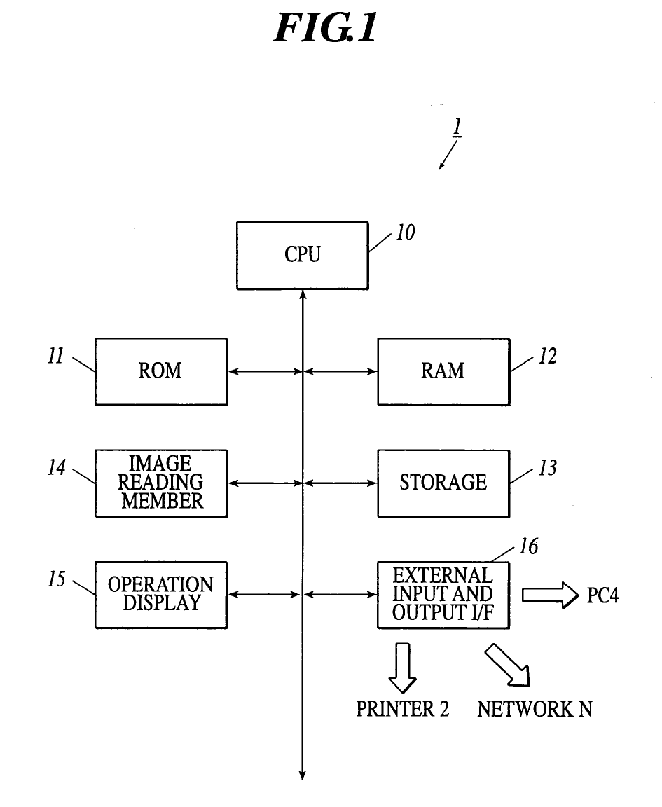

The block diagram of FIG. 1 shows a schematic constitution of the reading apparatus 1 to which the present invention is applied. A commercially available scanner is employed as the image reading apparatus 1, which irradiates light to an original and detects the light reflected on the original with a photoelectric conversion element, so as to obtain an digitized image data.

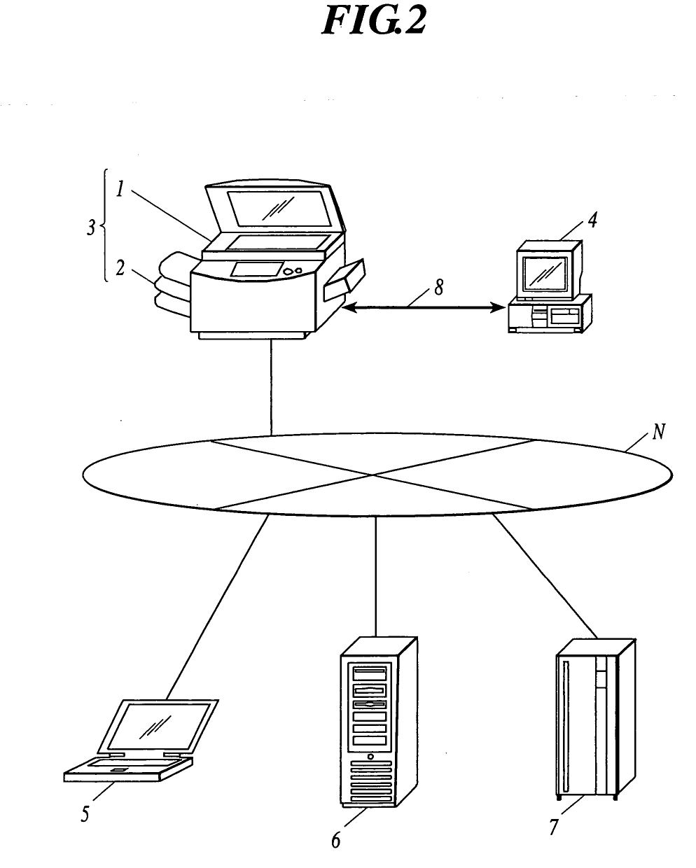

The reading apparatus 1 comprises a CPU (central processing unit) 10, ROM (read only memory) 11, RAM (random access memory) 12, storage 13, image reading member 14, operation display 15, and external input and output I/F (inter/face) member 16, those of which are connected one another electrically and electronically with main bus 18. As shown in FIG. 2, the reading apparatus 1 may be constituted integrally with a printer 2 so as to be a part of a copier 3, or may be connected with a PC (personal computer) 4 through a USB cable 8 so as to communicate with each other and the PC 4 works as the control system. In the present embodiment, a reading apparatus 1 is constituted as a part of the copier 3, is provided with the control system, further accepts an operation from the PC 4, and is constituted to be able to send read image data to a client PC 5, mail server 6, and FTP (file transfer protocol) server 7 through a network N.

In FIG. 1, the CPU 10 reads out an operation program or application program previously stored in the ROM 11 or storage 13, extracts them to the RAM 12 of a work area, and performs various processing, so as to control the reading apparatus 1 in whole. Specifically, the CPU 10 reads out a corrected area emphasizing program which is an operation program or application program previously stored in the ROM 11 or storage 13, detects a corrected area or the like where an original has been corrected or falsified by using a correction tape or sticking a correction sheet (hereinafter referred to as just a “corrected area”), and performs a “corrected area emphasizing process” to form an original image data where the detected corrected area is emphasized to be visually discernible.

The “corrected area emphasizing process” mainly performs an “area determining process” and “corrected area emphasized data forming process”. The “area determining process” is a process to automatically detect an area having highest gradation level in the original image data, especially an area having higher gradation level than that of the background of the original. The “corrected area emphasized data forming process” is a process to alter gradation level of the corrected area detected in the “area determining process”, and to form a corrected area emphasized image data where the corrected area is visually emphasized in the original image data obtained by the image reading member 14.

The gradation level represents gradation in a pixel basis. For example, it means that white color has high gradation level and black color has low gradation level.

The specific processing of the “area determination process” and “corrected area emphasized image data forming process” will be described later.

Back to FIG. 1, the ROM 11 is a read only memory composed of a non-volatile semiconductor element, and previously stores operation programs, various application programs and the like. The RAM 12 is a random readable/writable memory composed of a volatile semiconductor element such as a SRAM (static RAM) or DRAM (dynamic RAM), and functions as a work area.

The storage 13 is composed of a hard disk, flash memory of a non-volatile memory, and the like. The memory 13 stores an application program previously, or stores file data which is the original image data read in the image reading member 14 and the corrected area emphasized data formed in the “corrected area emphasized image data forming process”.

The image reading member 14 irradiates light to an original to be read, detects the reflected light with a photoelectric conversion element such as a CCD (charge coupled device) image sensor and CMOS (complementary metal-oxide semiconductor) image sensor, converts the detected analogue electric signal to a multilevel digital signal with an A/D converter (not shown), and outputs the digital signal to the CPU 10. The present embodiment may employ a reducing optical system using a lens system to concentrate the reflected light, a contact optical system using a rod lens array, or the like.

The external input and output I/F member 16 controls the communication with the PC 4 through a USB cable 8 (reception of an operation direction signal of the reading apparatus 1 and transmission of the read image data). Further, the external output and input I/F member 16 is connected to a network N such as LAN (local area network), MAN (metropolitan area network), WAN (wide area network), Internet and the like through NIC (network inter/face card) or the like, and controls external communication with a client PC 5, mail server 6 and FTP server 7 (reception of an operation direction signal of the reading apparatus 1 and transmission of the read image data).

The operation display 15 is a display monitor composed of a LCD (liquid crystal display) or the like, and is a display member to display various information of the reading apparatus 1 (configuration items, progress of processing, or the like). Further, the display screen thereof is composed of a touch panel, and can accept an input of various configurations such as resolution of image data, size of an original image, selection of whether color or black and white in reading, selection of whether single-sided or double-sided in reading, selection of corrected area emphasizing process, and the like.

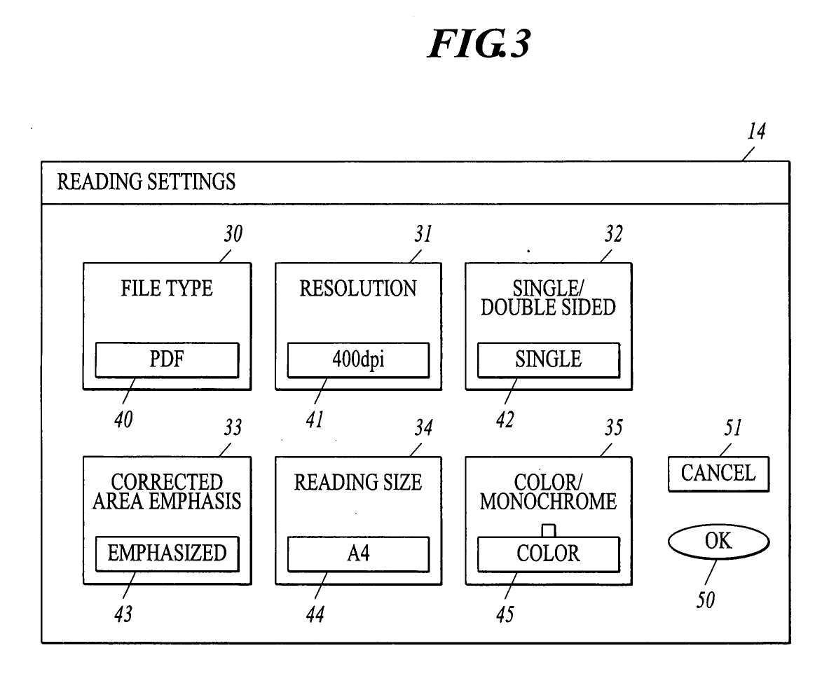

FIG. 3 shows one example of the screen displayed on the operation display 15. The screen displays a file format selection section 30 to display a configuration of a file format of a file storing the read image data and the corrected area emphasized image data formed in the corrected area emphasizing process, a resolution selection section 31 to display a configuration of resolution for reading the original image, a single/double-sided selection section 32 to display a reading configuration whether only single side or double sides is/are read in the image reading member 14, a corrected area emphasizing process selection section 33 to display a configuration whether or not the corrected area emphasizing process is executed, a reading size selection section 34 to display a configuration of size and area to be read of the original, and a color/black and white reading selection section 35 to display a reading configuration of whether color or black and white. The selection sections 30, 31, 32, 33, 34 and 35 are respectively provided with configuration buttons 40, 41, 42, 43, 44 and 45 which change the configurations and display of the configurations every time the buttons are pushed. FIG. 3 shows a default configuration (initial condition), where the file format is “PDF (portable document format)”, the resolution is “400 dpi”, the reading configuration of single side or double side is “single-sided”, the configuration of the corrected area emphasizing process is “emphasis (execute)”, the reading size is “A4”, and the reading configuration of color/black and white is “color”.

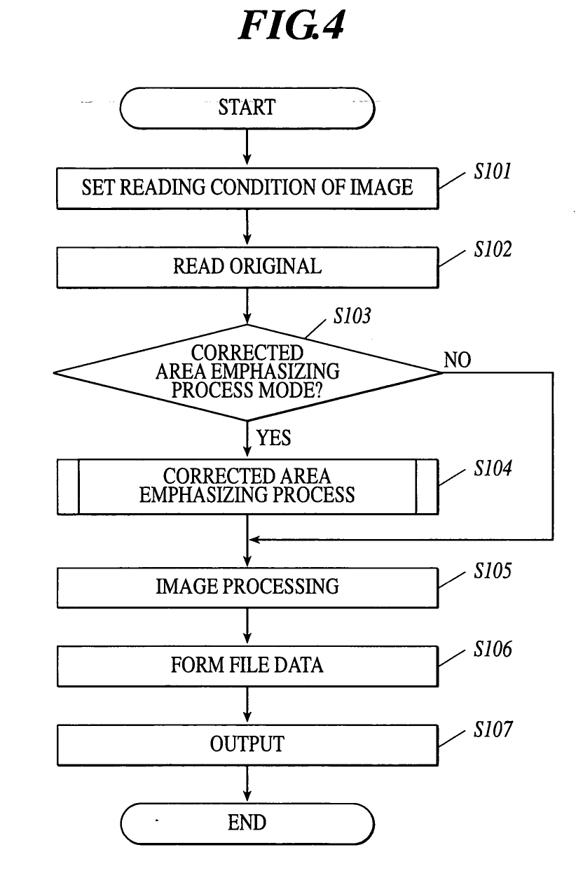

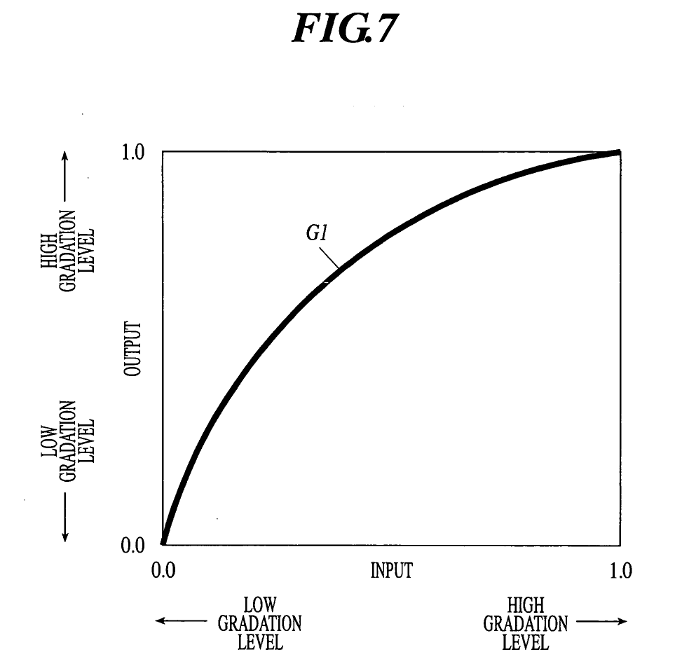

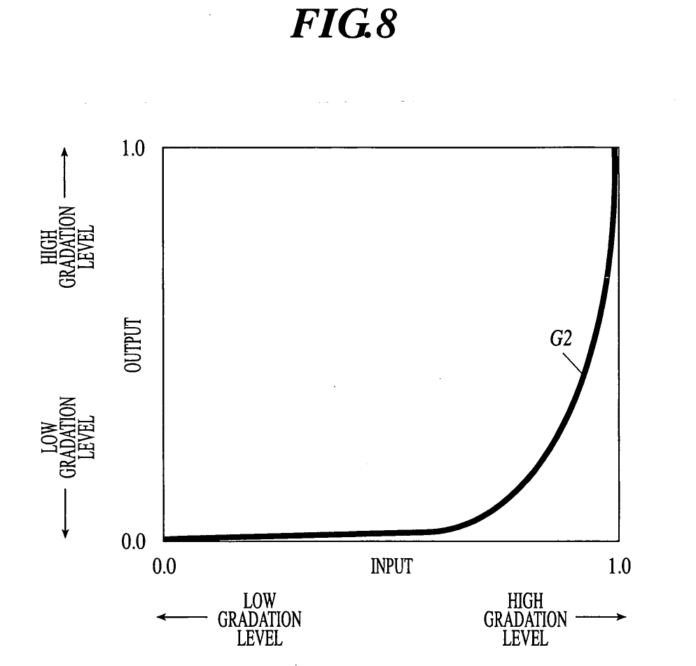

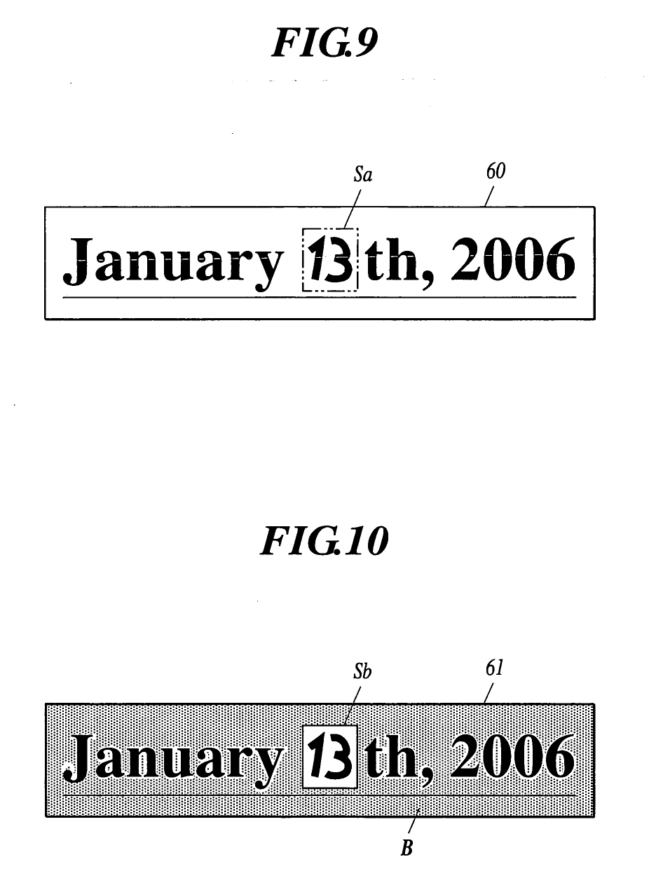

Next, an operation of the reading apparatus 1 and the “corrected area emphasizing process” will be described with reference to flowcharts shown in FIGS. 4, 5 and 6, schematic views showing transition of the original image data shown in FIGS. 9, 10, 11 and 12, and graphs showing displacement of gamma value shown in FIGS. 7 and 8. The CPU 10 performs the following various processes according to programs.

An image where “Jan. 13th, 2006” is written to a white recording paper is used as the original image to be read on the image reading member 14 for example, as shown in FIG. 9. Among the wording, “January” and “2006” are printed in a specific font where the image is not corrected, and “13” is an area where correction or the like has been made. A correction tape is attached to and the wording “13” is overwritten by hand to the corrected area. The recoding paper has whiteness of 80% and the correction tape has higher whiteness (for example 90%).

First, in step S101 of FIG. 4, a user sets a configuration of reading the original image by operating the operation display 15. For example, each item is configured as shown in FIG. 3. When an OK button 50 is pushed, the CPU 10 stores each item of the reading configurations in the RAM 12.

In step S102, the CPU 10 reads an original image by the image reading member 14 according to a direction signal to start reading which is formed based on user's operation.

In step S103, the CPU 10 refers to the configuration items stored in the RAM 12 in step S101, and judges whether or not a mode to perform the corrected area emphasizing process is set. When the mode of the corrected area emphasizing process is set, the process shifts to step S104 (step S103: Yes). When the mode of the corrected area emphasizing process is not set, the process shifts to step S105.

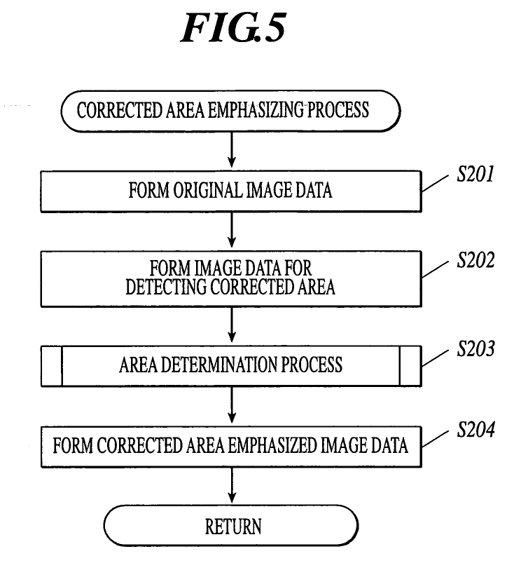

Hereinafter, the corrected area emphasizing process is described with reference to FIG. 5. In step S201 of FIG. 5, the CPU 10 forms the original image data of digitalized multi level image data from an analogue image signal obtained in the image reading member 14. FIG. 9 shows an image displayed on a display and printed to a printing paper in printing, which is formed based on original image data. In FIG. 9, a boundary of the recording paper and a correction tape trace Sa is barely discernible or not discernible visually at all. Particularly, when whiteness of the recording paper and correction tape is high, the boundary is generally not discernible visually at all. (Note that the boundary edge of the correction tape trace Sa and recording paper is partially indicated by two-dot chain line for descriptive purposes in FIG. 9.)

In step S202, the CPU 10 performs gamma correction to the original image data so as to form image data for corrected area detection 61 in which difference of gradation level between a background and corrected area is emphasized (see FIG. 10). Here, the gamma correction performed in the “corrected area emphasizing process” is described by comparing it with the gamma correction performed in the case where the “corrected area emphasizing process” is not performed.

FIG. 7 is a graph showing a property of the gamma correction performed in the case where the “corrected area emphasizing process” is not performed in the reading apparatus 1. In FIG. 7, a gamma curve G1 indicates that every gradation level in the original image data shifts higher, in which the shift amount is large in low gradation level and small in high gradation level. That is, the background of the recording paper has high gradation level (white or high gradation level gray), and an image (character or the like) recorded thereon has low gradation level (black, low gradation level gray, blue or the like). By doing so, gradation level of the image data having high gradation is made further higher so that the background is removed. Thus, contrast of the image increases, and the image becomes visually beautiful and also readable and sharp.

However as shown in FIG. 9, there hardly occurs difference in gradation level between the correction tape trace Sa and recording paper. Thus, it is difficult to discern the difference in the image data or in visual observation, even if the image data has not subject to the gamma correction yet. Further, the difference in gradation level between the correction tape trace and recording paper becomes smaller in the image data to which the gamma curve G1 of FIG. 7 has been applied. Thus, it is difficult to discern the difference in the image data or in visual observation. Therefore, in step S202, the gamma correction is performed based on a property shown as a gamma curve G2 of FIG. 8, so that gradation difference within high gradation level part of the image data is enhanced. FIG. 10 schematically shows an image of the original image data which have converted based on the gamma property shown in FIG. 8. In FIG. 10, a background area B of the recording paper is shown in low gradation level (light gray or the like), while the correction tape trace Sb is shown in higher gradation level than that of the background area. That is, the difference of the gradation level value therebetween is enhanced also in the image data, so that it becomes easy to discern the background area and corrected area.

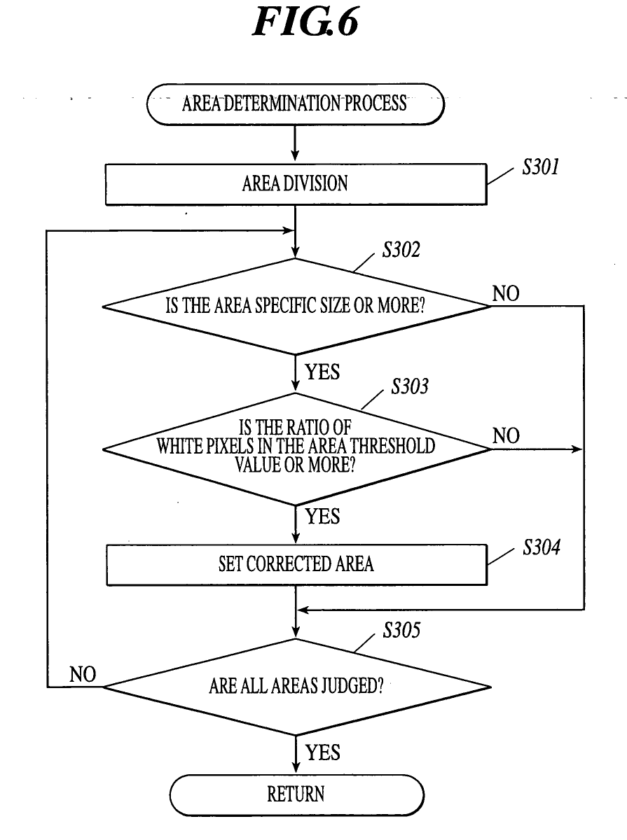

In step S203 of FIG. 5, the CPU 10 performs the “area determination process”, and determines the corrected area. FIG. 6 shows the flowchart of the “area determination process”. In step S301, the CPU 10 performs an area division process to divide the image data for corrected area detection 61 formed in step S202 (see FIG. 10) into specific areas. The area division process includes detecting color difference between each pixel.

The color difference is a difference of color between two colors represented numerically. In L*a*b* color scale, for example, three values of brightness of color (L*) and hue (a* and b*) are calculated when the two colors are measured with a calorimeter. As shown in the following formula 1, square root of the sum of each squared differences in L*, a* and b* between the two colors (referred to as ΔL*, Δa* and Δb* respectively) is generally called for color difference (ΔE*_{ab}). Similarly, in Lab color scale, three values of brightness of color (L) and hue (a and b) are calculated. As shown in the following formula 2, square root of the sum of each squared differences in L, a and b between the two colors (referred to as ΔL, Δa and Δb respectively) is generally called for color difference (ΔE_{H}).

$$\begin{matrix}Δ {E}_{a b}^{*} = {[ {( Δ {L}^{*} )}^{2} + {( Δ {a}^{*} )}^{2} + {( Δ {b}^{*} )}^{2} ]}^{\frac{1}{2}} & Formula 1 \\ Δ {E}_{H} = {[ {( Δ L )}^{2} + {( Δ a )}^{2} + {( Δ b )}^{2} ]}^{\frac{1}{2}} & Formula 2\end{matrix}$$

A sequence of pixels having similar color difference can be detected by calculating the color differences between adjacent pixels. Each of the sequence of pixels having similar color difference is divided as a specific area. The degree of the color difference is classified as shown in following Table 1.

TABLE 1

| TEXTILE TERMS | NBS UNIT |
|---|---|
| TRACE | 0 TO LESS THAN 0.5 |
| ALIGHT | 0.5 OR MORE TO LESS THAN 1.5 |
| NOTICEABLE | 1.5 OR MORE TO LESS THAN 3.0 |
| APPRECIABLE | 3.0 OR MORE TO LESS THAN 6.0 |
| MUCH | 6.0 OR MORE TO LESS THAN 12.0 |
| VERY MUCH | 12.0 OR MORE |

NBS represents National Bureau of Standards (now changed to National Institute of Standards and Technology (NIST))

A predetermined degree as shown in above Table 1 is set as threshold regarding the color difference between adjacent pixels, so that the area can be divided. In the present embodiment, an image data for corrected area detection forming process is previously performed in step S202 (see FIG. 5), so that the color difference between data of high gradation level and data of low gradation level is enhanced. Therefore, it is preferable that the threshold of color difference is as small as possible (for example, 2.5 at NBS unit or the like). In this case, the division can be performed with high accuracy, even when the color difference is small. Especially, when whiteness of the background area B (80%) is close to that of the correction tape (90%) as in the present embodiment, it is effective for discerning them each other.

Next, in step S302, the CPU 10 judges whether or not size of the area divided in step S301 (the number of pixels included in the area) is a predetermined size (predetermined pixels) or more. That is, when a correction tape or correction agent is used, the correction is generally made in a unit of letters, lines, or a part of a letter. Thus, the corrected area has certain size (a plurality of pixels). An expected minimum size of an area to be corrected, for example in Japanese language, an area corresponding to one “,” (comma) is set as a threshold area (threshold pixel number), and it is judged whether or not the divided area is the corrected area.

In step S302, when the CPU 10 judges that size of the divided area (pixel number of the divided area) is the threshold size (threshold pixel number) or more, the process shifts to step S303 (step S302: Yes). On the contrary, when the CPU 10 judges that size of the divided area (pixel number of the divided area) is less than the threshold size (threshold pixel number), the process shifts to step S305.

In step S303, the CPU 10 further judges whether or not the ratio of white pixels included in the divided area is a threshold or more. That is, the CPU 10 judges whether each pixel included in the divided area is a white pixel or not, based on RGB gradation level data of the pixel (i.e. gradation levels of R, G and B are close to 255, 255 and 255 respectively). The CPU 10 further judges whether or not-a ratio of the pixel data judged as the white pixel in the divided area is a white pixel threshold or more (for example, the number of pixels judged as white pixel is 80% or more).

The divided area formed in the process prior to step S302 has a size of the threshold area or more. However, each area is an assembly of pixels having similar gradation level (the gradation level is various from black to white). Thus, CPU 10 judges the white gradation level of the divided area, so as to judge whether or not the divided area is corrected area.

When the CPU 10 judges in step S303 that the ratio of white pixels in the divided area is the white pixel threshold (the number of pixels judged as white pixel is 80%) or more, the process shifts to step S304 (step S303: Yes). On the contrary, when the CPU 10 judges that the ratio of white pixels in the divided area is less than the white pixel threshold, the process shifts to step S305.

In step S304, the CPU 10 extracts coordinate data on the image data of the divided area judged as the corrected area, and recognizes it as the corrected area. FIG. 11 schematically shows the corrected area which can be given when all of the coordinate is extracted. In the figure, the correction tape trace Sc can be recognized as the corrected area.

Thereafter, in step S305, the CPU 10 judges whether or not the judgment has been done to all of the divided areas. When it is judged that all of the divided areas have been judged, the process gets back to step S204 of the corrected area emphasizing process. When it is judged that there is a divided area which has not judged yet, the step gets back to S302 and the CPU 10 performs the judgment on the left divided area.

In the case of step S302: No and step S303: No, the process also shifts to step S305 and the CPU 10 performs the judgment similarly.

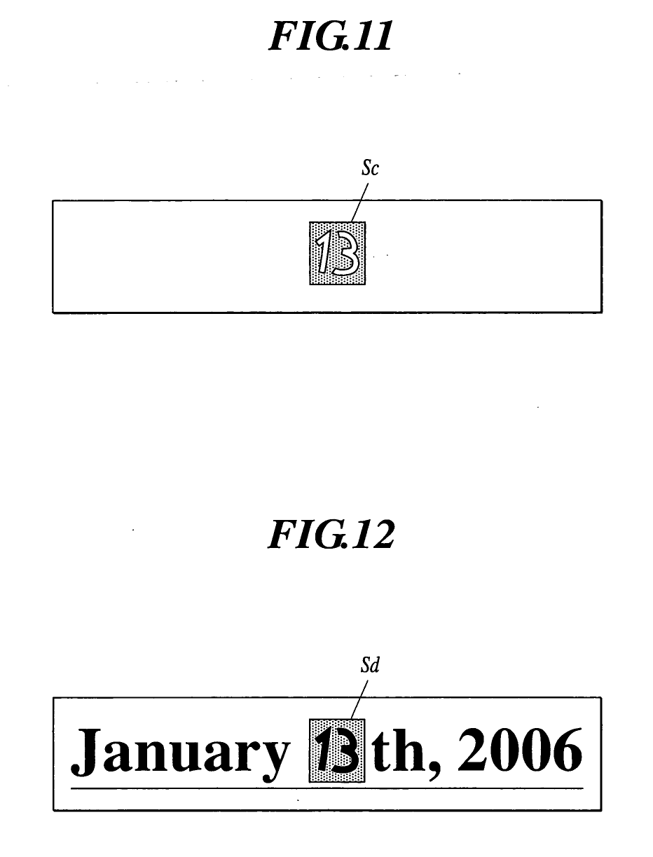

Back to the corrected area emphasizing process shown in FIG. 5, in the step S204, the CPU 10 performs the corrected area emphasized image data forming process which alters gradation level of a pixel corresponding to the coordinate data on the original image data based on the coordinate data of the corrected area extracted in step S304 of the above-described area determination process on the original image data. FIG. 12 schematically shows an image of the original image data where the correction tape trace Sd of the corrected area is expressed with emphasis. The alternation of the gradation level at the correction tape trace Sd which is the corrected area includes both of altering to other color and just altering brightness. It is preferable that the color and/or brightness of the corrected area is altered to different color and/or brightness from those of the background of the original image. Alternatively, the corrected area may be emphasized by surrounding the corrected area with a frame. The emphasizing process can be changed variously within a scope where the corrected area is made discernible.

After the corrected area emphasizing process of step S201 to S204 (which includes the area determination process of step S301 to S305) is performed, the CPU 10 shifts the process to step S105 in the flowchart of FIG. 4.

In step S105, the CPU 10 converts pixel data whose color differences are close to each other to pixel data having similar color difference in the image data of original to which gradation level of the correction tape trace Sd has been converted by the corrected area emphasized image data forming process of step S204, so that the CPU 20 performs a final image processing to form image data where the background and image area are clearly discernible and the image has high contrast.

In step S106, the CPU 10 performs a process to convert the image data of original, to which the final image processing of step S105 has been given, to data file of a predetermined file format based on the previously set file format (for example PDF or GIF).

In step S107, the CPU 10 stores the file data formed in step S106 to the storage 13, and outputs the file data to the PC 4, network N or printer 2 through the external input and output I/F member 16 (see FIGS. 1 and 2).

According to the reading apparatus 1 of the present embodiment, it is possible to form image data in which gradation difference is emphasized in higher gradation level by applying the gamma correction curve G2 to the read original image data. Therefore, it is possible to determine more reliably the corrected area composed of high gradation level data for a divided area having predetermined size. Moreover, it is possible to convert the image data to image data where this corrected area has different gradation level from that of the background, so as to form and output the image data where the corrected area is emphasized to be visually discernible on the original image data. As a result, when the original image is displayed on a monitor or printed based on the data to which the corrected area has been emphasized, the corrected area can be determined at a glance.

Moreover, since the original image data to which the corrected area has been emphasized can be converted to a predetermined file format, the original image data can be saved in various file format and be sent easily to the other terminal or the like through a cable or network.

Moreover, since it can be configured whether or not the emphasizing process of the corrected area is performed, the reading apparatus can be used as a normal reading apparatus when the emphasizing process is not performed. Thus, the reading apparatus has superior general versatility.

The preferred embodiment to carry out the invention is described in the foregoing description, and is disclosed for the purpose to exemplify the invention. Thus, the present invention is not limited thereto, and can be subject to various modifications, alternation addition and the like within a scope of a sprit of the invention. In particular, although the corrected area is determined based on whiteness of the recording paper and correction tape in the present embodiment, it is also possible to determine the corrected area base on difference in glossiness between the recording paper and correction tape instead of whiteness.

In step S202 of the corrected area emphasizing process (see FIG. 6) of the present embodiment, the CPU 10 performs the gamma correction on the original image data obtained in the image reading member 14 and forms the image data where gradation difference is enhanced in higher gradation level. When there is a remarkable difference in whiteness between the original and correction tape or the like, it goes without saying that the corrected area can be determined without such gamma correction. For example, when the original is a base material or course paper used for a newspaper or magazine having whiteness of about 55% and the correction tape has whiteness of 90%, the difference of whiteness is often inherently remarkable in the read original image data itself. In these cases, the corrected area can be determined automatically without the gamma correction. Thus, some steps can be omitted, and burden and time for the omitted steps can be reduced.

In steps S301 and S302 of the area determination process (see FIG. 11), the area is divided based on color difference information of each pixel, and it is judged whether or not the divided area has particular size or more. Alternatively, the process can be also constituted as follows. The CPU 10 judges every pixel based on white pixel threshold without dividing an area, and extracts a coordinate of the pixel over the threshold in the original image data. Thereafter, the CPU 10 determines an area where the selected pixels continue to be particular size as the corrected area. In this process, area division process can be omitted, and burden and time for the omitted process can be reduced.

Moreover, the present embodiment also includes the following constitution.

That is, included is an image processing apparatus comprising an image processing member to form an image data where the original image data obtained by reading the original image is processed so that the background area and corrected area are discernible each other.

Since the background and corrected area are processed to be discernible each other, even when a description in the original has been simply deleted by a correction pen or correction tape, the corrected area as the deleted area can be discerned from the background area. In a method to detect a correction or falsification based on a font used in the original image, it is impossible to detect a correction of falsification of simple deletion. However, the present constitution can deal with such correction or falsification of such simple deletion.

1. An image processing apparatus comprising:
an image processing member which detects a corrected area of an original image based on gradation level of original image data obtained by reading the original image, and forms image data where the corrected area is processed to be discernible.

2. The image processing apparatus of claim 1, wherein the image processing member comprises:
a detecting section which detects the corrected area; and
an emphasizing section which processes the corrected area to be discernible.

3. The image processing apparatus of claim 2, wherein the detecting section detects the corrected area of the image data based on gradation level of a background area of the original image data.

4. The image processing apparatus of claim 2, wherein the detecting section detects the corrected area of the original image data based on gradation level higher than gradation level of a background area.

5. The image processing apparatus of claim 2, wherein the image processing member further comprises:
a gradation correction section which performs a gradation correction process of enhancing gradation difference in high gradation level,
wherein the detection section detects the corrected area of the original image data based on the image data which is converted in the gradation correction section.

6. The image processing apparatus of claim 2, wherein the emphasizing section converts gradation level of the corrected area of the original image data to different gradation level from gradation level of a background area.

7. The image processing apparatus of claim 2, further comprising: a file converting member which converts image data converted in the emphasizing section into file data of a predetermined format.

8. The image processing apparatus of claim 1, wherein the image processing member comprises:
a central processing section, and
a memory which stores a program executed by the central processing section,
wherein a process executed in the image processing member is realized by the central processing section executing the program.

9. The image processing apparatus of claim 2, further comprising: a setting member which sets whether or not a conversion by the emphasizing section is performed.

10. An image processing method comprising the steps of:
detecting a corrected area of an original image based on gradation level of original image data obtained by reading the original image, and
forming image data where the corrected area of the original image data is processed to be discernible.

11. The image processing method of claim 10, wherein in the detecting step, the corrected area in the original image data is detected based on the highest gradation level in the original image data.

12. The image processing method of claim 10, wherein in the detecting, the corrected area of the original image data is detected based on gradation level higher than gradation level of a background area of the original image data.

13. The image processing method of claim 10, further comprising the step of: performing a gradation correction process to the original image data, the gradation correction process being to enhance a gradation difference in high gradation level,
wherein in the detecting step, the corrected area of the original image data is detected based on gradation level of image data obtained by the gradation correction process.

14. The image processing method of claim 10, wherein in the forming step, gradation level of the corrected area of the original image data is converted to different gradation level from gradation level of a background area.

15. The image processing method of claim 10, further comprising the step of: converting image data formed in the forming step to file data of a predetermined format.

16. The image processing method of claim 10, further comprising the step of: setting whether or not image data is formed by the forming step.

17. A program for causing a computer to carry out a the functions of:
a detecting function which detects a corrected area of an original image based on gradation level of original image data obtained by reading the original image, and
an emphasizing function which forms image data where the corrected area of the original image data is processed to be discernible.

18. The program of claim 17, wherein in the detecting function, the corrected area is detected based on highest gradation level of the original image data.

19. The program of claim 17, wherein in the detecting function, the corrected area of the original image data is detected based on gradation level higher than gradation level of a background area of the original image data.

20. The program of claim 17, further comprising the functions of:
a gradation level correcting function which enhances gradation difference in high gradation level of the original image data,
wherein in the detecting function, the corrected area of the original image data is detected based on gradation level of image data outputted in the gradation level correcting function.

21. The program of claim 17, wherein in the emphasizing function, gradation level of the corrected area is converted to different gradation level from gradation level of a background area.

22. The program of claim 17, further comprising the function of: a file converting function which forms file data of a predetermined format from image data outputted in the emphasizing function.

23. The program of claim 17, further comprising: a setting function which sets whether or not a conversion by the emphasizing function is performed.

24. A computer-readable recording medium storing a program of claim 17.

25. The program of claim 18, further comprising the functions of:
a gradation level correcting function which enhances gradation difference in high gradation level of the original image data,
wherein in the detecting function, the corrected area of the original image data is detected based on gradation level of image data outputted in the gradation level correcting function.

26. The program of claim 19, further comprising the functions of:
a gradation level correcting function which enhances gradation difference in high gradation level of the original image data,
wherein in the detecting function, the corrected area of the original image data is detected based on gradation level of image data outputted in the gradation level correcting function.
